(19) United States
(12) Patent Application Publication
(10) Pub. No.: US 2026/0246143 A1
(43) Pub. Date: Aug. 20, 2026

(54) Systems And Methods For Electronically Configuring a Phased Array Antenna

(71) Applicant: RAVE Aerospace, LLC, Brea, CA (US)

(72) Inventors: Peter Lewalter, Weßling (DE); Matteo Berioli, Munich (DE)

(73) Assignee: RAVE Aerospace, LLC, Brea, CA (US)

(21) Appl. No.: 19/149,523

(22) PCT Filed: Sep. 26, 2023
(86) PCT No.: PCT/US2023/075147

§ 371 Date: Jul. 18, 2025

Related U.S. Application Data
(60) Provisional application No. 63/495,045, filed on Apr. 7, 2023.

(51) Int. Cl. H01Q 3/34; H01Q 1/28; H01Q 21/00

(52) U.S. Cl. CPC H01Q 3/34; H01Q 1/28; H01Q 21/00

(57) ABSTRACT

Various telecommunication antennas are described comprising a phased-array antenna having a plurality of antenna elements arranged in an array. The antenna further comprises electronics configured to electronically divide the antenna elements into two or more sub-arrays, which each comprise a subset of the plurality of antenna elements. The electronics can dynamically reorient the antenna by electronically dividing the antenna elements into different sub-arrays of the antenna elements which thereby affect the beam patterns of each of the sub-arrays.

This application claims priority to U.S. provisional patent application having Ser. No. 63/495,045 filed on Apr. 7, 2023. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is phased array antennas.

### BACKGROUND

The following description includes information that may be useful in understanding the present invention. It is not an admission that any of the information provided herein is prior art or relevant to the presently claimed invention, or that any publication specifically or implicitly referenced is prior art.

The provisioning of an aircraft with the ability to link to satellite communication networks necessarily entails the use of antenna, which is generally external to the aircraft.

Unlike ground-based or maritime craft, however, the need to provide a suitably aerodynamic profile sets limitations on the size and configuration of such antenna, which can limit the antenna's performance.

One antenna configuration currently in avionic use is a rectangular antenna that lies along or is angled relative to the aircraft's surface. Such an antenna is steered mechanically to adjust azimuth. Similarly, elevation is adjusted mechanically. Such antennae are commercially available through various companies such as Honeywell™, Zodiac Data Systems™, Astronics™, Gilat™, and Viasat™.

The focus of the discussion below concerns the transmission arrays, since the shape of the transmission beams is strongly regulated by international authorities to avoid that an antenna pointing in a wanted direction, creates interference in unwanted directions through sidelobes or “too wide” beams. Exemplary international authorities include, for example, the International Telecommunications Union (ITU), the Federal Communications Commission (FCC), and the European Telecommunications Standards Institute (ETSI).

In order to assess if a beam is too wide or narrow enough, the three-dimensional antenna beam pattern is cut along a certain direction and its power level (i.e., the energy spectral density (ESD) and the Effective Isotropic Radiated Power (EIRP) Spectral Density) is compared with the maximum allowed power as provided by the regulatory masks. If the ESD exceeds the mask, then the power level has to be reduced. Typically, if a beam is too wide along certain directions, skew cuts (or generally beam cuts) along that direction more easily result in violations of the mask. For this reason, it is common for prior art antennas to be designed with a symmetric antenna panel, such that all cuts (in different skew angles) and in different azimuth angles result in similar performance.

FIG. 1 illustrates a schematic of a prior art antenna described in U.S. pat. publ. no. 2014/0145887 that utilizes a two-axis rectangular gimble to mechanically rotate the antenna panel and thereby steer the beam pattern of the antenna, which is defined as the graphical representation of the radiation properties of the antenna as a function of space. In other words, the antenna's beam pattern describes how the antenna radiates energy out into space or how the antenna receives energy. While such antenna generally can support satellite communication over a broader range of latitudes, the antenna typically has a skew angle issue resulting from beam asymmetry that limits its use at longitudes far from the target satellite to avoid interference to neighboring satellites.

An at least partial solution to the skew angle problem experienced with this type of antennae is to mechanically rotate the asymmetric beam produced so that the longer plane of the beam is orthogonal to the arch described by the set of communication satellites. For example, if there is interference created along the geo arch for a specific orientation of the rectangular panel (where the beam pattern is wide along the geo arch), it is possible to mechanically rotate the antenna panel and steer the beam electronically in the satellite direction (compare the left depiction of the antenna with the right depiction of the antenna in FIG. 1). In this manner, the antenna can possibly offset the beam with respect to the main broadside direction of the antenna panel (i.e., to offset the beam direction from the main perpendicular direction of the rectangle). In this way, the width of the beam pattern along the geo arch is much smaller, and interference is avoided.

While such solution can reduce the amount of interference to non-target satellites, the solution adds to the complexity of the communication system and may not be suitable for harsh operating environments (where mechanical systems can be unreliable).

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for antennae that support communication over a wide range of latitudes while minimizing interference.

### SUMMARY OF THE INVENTION

The inventive subject matter provides apparatus, systems, and methods for phased array antennas having one or more antenna panels. Preferred antennas comprise a telecommunications antenna such as may be used in aircraft, boats, trains, and other vehicles. Each antenna panel preferably comprises a plurality of antenna elements that are disposed in an array and radiate in phase coherence. Typically, the number of elements is inversely proportional to the size of the elements. It is contemplated that antenna elements can be arranged in a square grid, rectangular grid, triangular grid, a polygonal grid, or other arrangement.

By electronically changing the phase shift introduced by a subset of the array of antenna elements, it is possible to steer the antenna beam in different directions. In other words, it is possible to dynamically adjust the antenna to “look” in different directions without requiring the antenna panel to be mechanically rotated. This is true for both for receiving (RX) and transmission (TX) arrays.

The inventive subject matter discussed herein is focused on this ability to electronically reorient the antenna or a sub-array of the antenna. Specifically, the inventive subject matter herein focuses on the problem of splitting a transmission array into two or more sub-arrays in an optimal way that works to maximize antenna performance while complying with regulatory requirements of international bodies that control the mutual interference between satellite networks. The inventive subject matter is advantageous, especially where the orientation of the antenna is known with respect to the critical cuts in the sky against which regulatory mask have to be respected (e.g., the geostationary arch). In such circumstances, it is possible to re-orient the panel, and thus the beam, so that the violation of the mask can be avoided.

For the purpose of the discussion herein, an analog phased-array beamforming network is defined as a network that can only create one antenna beam. The beam pattern informs in which angular directions the antenna has higher or lower gain, or, in other words, in which direction the antenna is “looking”.

If an antenna needs to “look” or point in different directions at the same time, multiple beams have to be created. If multiple beams are required, multiple combination networks need to be implemented behind the antenna elements. To limit the hardware complexity, especially at the radio-frequency (RF) chip level, it is contemplated that the antenna panel (array) can be split or subdivided into two or more sub-arrays and have separated combination networks in parallel.

In this case, each combination network can utilize one of the sub-arrays, i.e. one part of the array area, and thus the resulting phased-array antenna performance is scaled down, because the antenna aperture area is reduced and consequently the associated antenna gain is reduced. The antenna gain as a function of the antenna area can be calculated using well known formulas.

For example, when the antenna is pointing to a desired satellite (i.e., the “wanted” direction), the beam pattern has to respect a regulatory mask and limit the radiation of power in some specific “unwanted” direction, especially to protect other nearby satellites from interference. The geostationary orbit (GEO) arch is a special line in the sky where many satellites are located close to each other, and when a terminal is pointing toward one satellite, it is important that power is not radiated to the satellites adjacent to the “wanted” one. If the GEO arch happens to be aligned with the long axis of the antenna beam pattern, it is difficult to avoid interference. Under those circumstances, the user terminal typically is required to back-off transmission power and reduce the throughput. Using the inventive subject matter discussed herein, under such circumstances, the asymmetric panel can instead be electronically re-oriented (e.g., rotated 90°). This causes the GEO arch to be aligned to the short axis of the antenna beam pattern and no longer to the long axis, thereby minimizing interference and eliminating the need for the user terminal to back-off transmission power.

Various advantages are possible as a result of the ability to electronically reorient an antenna, using the concepts described herein. First, a single phased array antenna can be used to point to multiple satellites at the same time by dividing the array into two or more sub-arrays even if the sub-arrays result in asymmetric panels. Second, asymmetric transmission sub-arrays can be used more efficiently (i.e., always at maximum transmission power), because the sub-arrays can be re-oriented in different directions to minimize interference with other satellite networks, and thus result in higher average throughputs. Third, the antenna can maintain compliance with regulatory constraints and EIRP spectral density masks while still achieving high throughputs. Fourth, the total aperture area of the antenna can be maximized to thereby keep the antenna area small, limiting cost and power requirements. Otherwise, a larger panel area would be required which requires more RF chips that in turn consume higher power.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a prior art antenna.

FIG. 2 is one embodiment of an analog phased array antenna divided into two sub-arrays.

FIG. 3A is the analog phased array antenna of FIG. 2 divided into two different sub-arrays.

FIG. 3B illustrates exemplary directions in which the beam of the analog phased array antenna of FIG. 3A may point.

FIG. 4 illustrates an example of skew cuts of an in-axis (main beam) of the sub-array shown in FIG. 2.

FIG. 5 illustrates an example of skew cuts of an in-axis (main beam) of the sub-array shown in FIG. 3.

FIGS. 6A-6B illustrate another embodiment of an analog phased array antenna divided into two sub-arrays, with the antenna being reconfigured from a first configuration shown in FIG. 6A to a second configuration shown in FIG. 6B.

FIGS. 7A-7B illustrate another embodiment of an analog phased array antenna divided into two sub-arrays, with the antenna being reconfigured from a first configuration shown in FIG. 7A to a second configuration shown in FIG. 7B.

FIGS. 8A-8B illustrate exemplary antenna diagrams plotted in a u-v coordinate system, with FIG. 8A showing a first configuration option of the sub-arrays and FIG. 8B showing a second option of the sub-arrays.

FIGS. 9A-9B illustrate additional, exemplary antenna diagrams plotted in a u-v coordinate system, with FIG. 9A showing a first configuration option of the sub-arrays and FIG. 9B showing a second option of the sub-arrays.

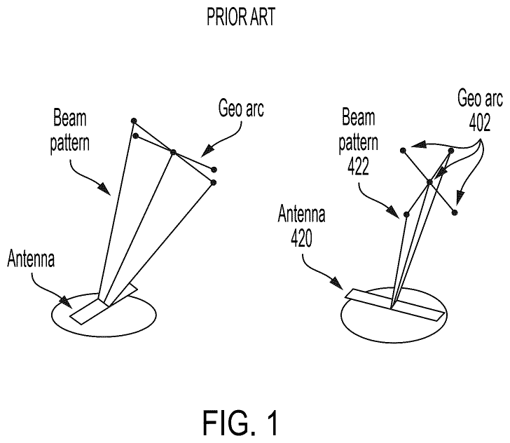

### DETAILED DESCRIPTION

Throughout the following discussion, numerous references will be made regarding servers, services, interfaces, portals, platforms, electronics or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

It should be appreciated that devices and systems of the inventive concepts described herein advantageously provide a robust and effective antenna system that permits aircraft to communicate with telecommunications satellites within their operating latitudes while minimizing the impact on aircraft performance (e.g., reduce drag from the antenna).

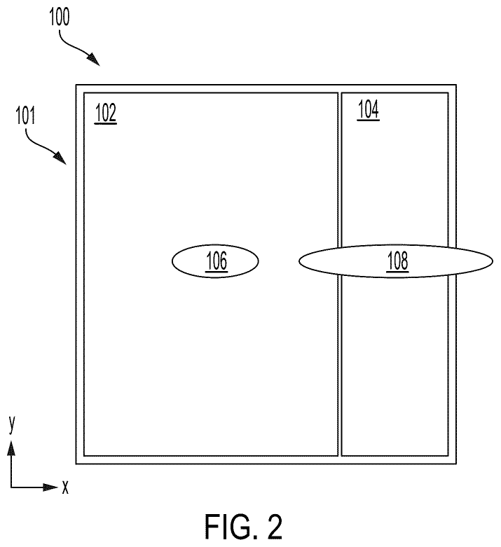

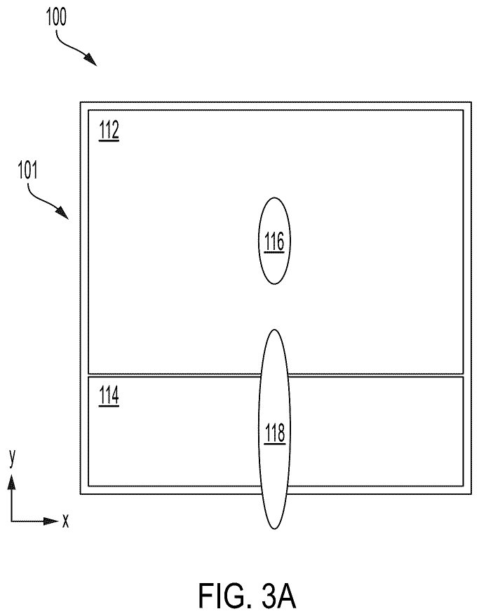

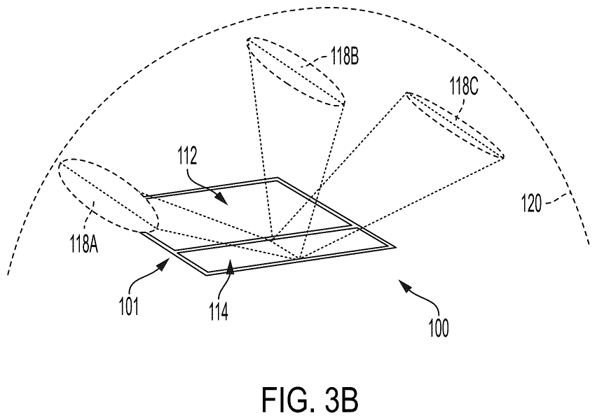

FIGS. 2-3 illustrate one embodiment of an antenna 100 suitable for use in communication between an aircraft and a communication satellite. Antenna 100 comprises an analog phased array having an antenna panel 101, which preferably has a rectangular shape. The antenna panel 101 preferably comprises a plurality of transmission elements. However, in some embodiments, it is contemplated that the antenna panel 101 could comprise a plurality of transmission and receiving elements, which may be interlaced/integrated in the antenna panel 101. The antenna panel 101 can be fed electronically or with a suited beam forming network. The specific number of antenna panels and the overall shape of the antenna panel 101 can be varied without departing from the scope of the invention discussed herein.

Preferably, the transmission elements are integrated uniformly in each antenna panel 101.

As shown in FIG. 2, the antenna panel 101 can be electronically divided or split into a first sub-array 102 and a second sub-array 104. Splitting the antenna panel 101 into multiple sub-arrays allows for the creation of multiple beams but may create asymmetric geometries for the sub-arrays that could be rectangular even if the starting full panel is square. Thus, using the inventive subject matter discussed herein, the antenna panel 101 can create multiple beams on a “shared” aperture by dynamically splitting or dividing the panel 101 into the sub-arrays 102, 104. Preferably, each of the sub-arrays comprise a rectangular shape. It is contemplated that each of the sub-arrays 102, 104 can direct or “point” its beam in a specific direction that is different from the other sub-array.

The geometric shape of each phased-array sub-array 102, 104 has a strong impact on the shape of the beam that each sub-array creates. For example, asymmetric sub-arrays (i.e., rectangular, non-square panels) will create asymmetric beam patterns (wider in one direction and narrower in the orthogonal direction), and the length of the sub-array along a certain direction is inversely proportional to the angular width of the beam (beamwidth) on the planes parallel to that direction. In other words, the larger and more symmetric the dimensions of the sub-array, the narrower the beam. Conversely, the more asymmetric the dimensions of the sub-array, the wider the beam. Thus, an elongated sub-array will have a wider beam than a square-shaped sub-array. The asymmetric sub-arrays may have critical beam shapes along some azimuth directions and skew cuts. The criticality depends on the size of the sub-array and on the degree of asymmetry of the sub-array.

This can be seen in FIG. 2 where the main lobe of the beam generated by each sub-array 102, 104 is overlaid on the respective sub-array. For example, beam 108 of the smaller and more asymmetric second sub-array 104 is larger than beam 106 of the first sub-array 102 that is larger and more symmetric. As discussed above, beam 108 is inversely proportional to the angular width of the beam (beamwidth) on the planes parallel to that direction (i.e., the shorter side of the rectangle).

While FIG. 2 illustrates an antenna panel 101 split into two sub-arrays 102, 104 (with two resulting beams 106, 108), it is contemplated that the antenna panel 101 could instead be split into three or more sub-arrays. The primary limit in the number of sub-arrays that can be created is the resulting size of the sub-arrays. By increasing the number of sub-arrays for the panel 101, each sub-array becomes smaller and thus the antenna gain also becomes smaller and the beam larger in beamwidth, up to the point where the gain of the sub-array is not enough to close the link budget with the satellite, and the beamwidth may no longer comply with regulatory limits imposed to avoid interference with other satellite networks.

FIGS. 3A-3B illustrate the antenna panel 101 electronically divided or split into a different set of sub-arrays, namely a first sub-array 112 and a second sub-array 114. As shown in the Figures, each of the first sub-array 112 and the second sub-array 114 have a different shape than the sub-arrays 102, 104 shown in FIG. 2. As a result of the change in how the antenna panel 101 is split, the resulting main lobe of the beam generated by each sub-array 112, 114 also changes. As explained above, this is because the size of the sub-array along a certain direction (e.g., width or length) is inversely proportional to the angular width of the beam (beamwidth) on the planes parallel to that direction. Here, beam 118 of the smaller and more asymmetric second sub-array 114 is now wider along an x-axis than the beam 108 shown in FIG. 2 that is wider along a y-axis. Those less pronounced, the same is true of beam 116 of the first sub-array 112. Essentially, the major and minor axes of each beam pattern has been interchanged from that shown in FIG. 2.

Examples of the various directions beam 118 may point are shown in FIG. 3B, while maintaining the same orientation. For example, FIG. 3B illustrates three possible directions for the beam (e.g., beam 118A, beam 118B, and beam 118C) along arch 120, although these are not exhaustive.

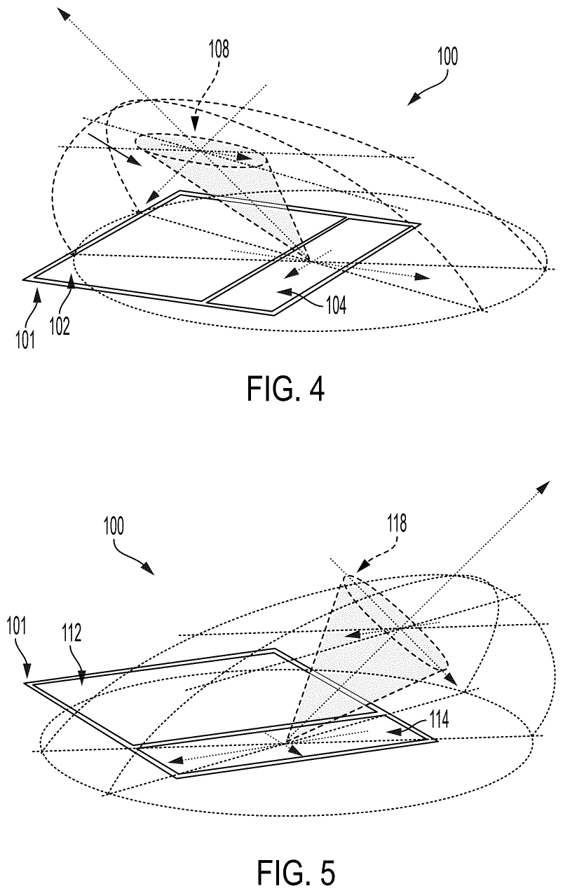

Thus, without requiring physical rotation of the antenna panel 101 such as by using a mechanical gimbal described in the prior art, the antenna panel 101 can be dynamically reoriented using the electronics of the antenna 100 (here, by 90 degrees) thereby changing the beam pattern of each sub-array 102, 104 (wider in one direction and narrower in the orthogonal direction) by electronically changing the phase shift introduced by each subset of the antenna elements. The effect of such electronic reorientation of the antenna panel 101 can be seen by comparing FIGS. 4 and 5, which are described below.

FIG. 4 illustrates an example of skew cuts for the in-axis (main) beam 108 of the second sub-array 104 of the antenna 100 shown in FIG. 2. As shown, the beamwidth is wide along the skew cuts.

FIG. 5 illustrates an example of skew cuts for the in-axis (main) beam 118 of the second sub-array 114 of the antenna 100 shown in FIG. 3. As shown, the beamwidth is narrow along the skew cuts.

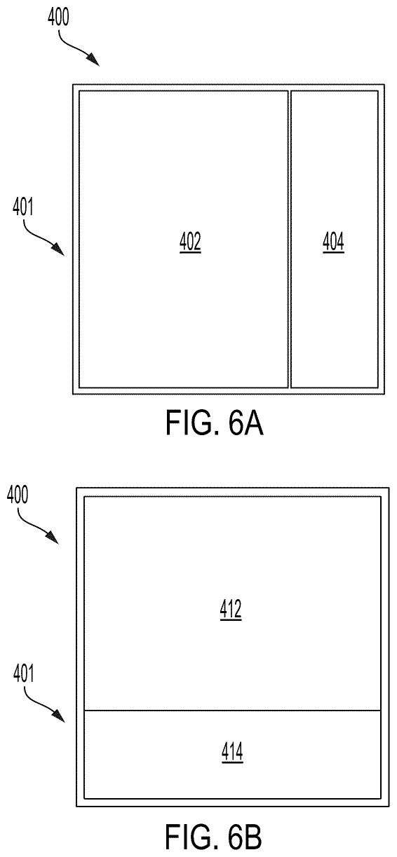

FIG. 6A illustrates another embodiment of an antenna 400 suitable for use in communication between an aircraft and a communication satellite. Antenna 400 comprises analog phased array having an antenna panel 401, which preferably has a rectangular shape. The antenna panel 401 preferably comprises a plurality of transmission elements arranged in a 52×52 array for a total of 2,704 elements.

The antenna panel 401 can be electronically divided or split into a first sub-array 402 and a second sub-array 404. Preferably, each of the sub-arrays comprise a rectangular shape. It is contemplated that each of the sub-arrays 402, 404 can direct or “point” its beam in a specific direction that is different from the other sub-array.

In an exemplary embodiment, it is contemplated that the first sub-array 402 comprises a first subset of the transmission elements arranged in a 52×36 array, while the second sub-array 404 comprises a second subset of the transmission elements arranged in a 52×16 array.

FIG. 6B illustrates the antenna 400 having antenna panel 401, which is electronically and dynamically reconfigured from that shown in FIG. 6A and is now divided or split into a different first sub-array 412 and a different second sub-array 414. In this embodiment, it is contemplated that the sub-array 412 comprises a first subset of the transmission elements arranged in a 36×52 array, while the second sub-array 414 comprises a second subset of the transmission elements arranged in a 16×52 array.

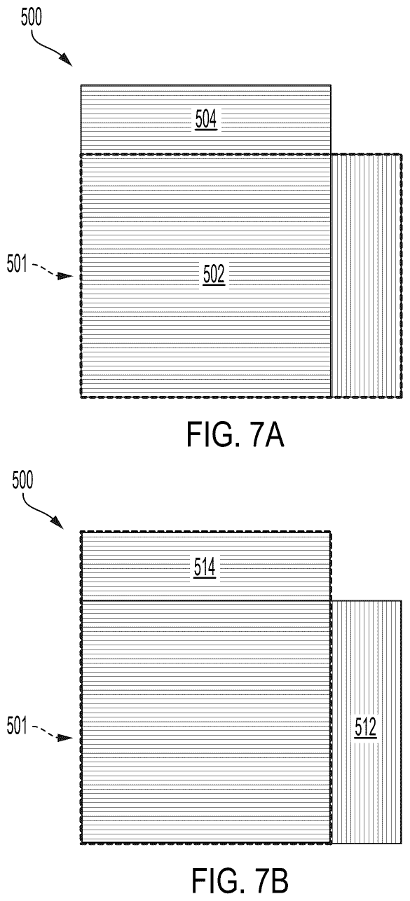

FIGS. 7A-7B illustrate two different configurations of an antenna 500 in which the antenna panel 501 is divided into a first sub-array 502 and a second sub-array 504 shown in FIG. 7A and can be dynamically reconfigured into a different set of sub-arrays as shown in FIG. 7B, namely sub-array 512 and sub-array 514. As shown, the antenna panel 501 comprises a polygon shape formed of multiple rectangles, while each sub-array is rectangular in shape. The hatched box defines sub-array 502 in FIG. 7A and sub-array 514 in FIG. 7B. In this embodiment, the recombination network hardware may be simpler than for the antenna 400 shown in FIGS. 6A-6B.

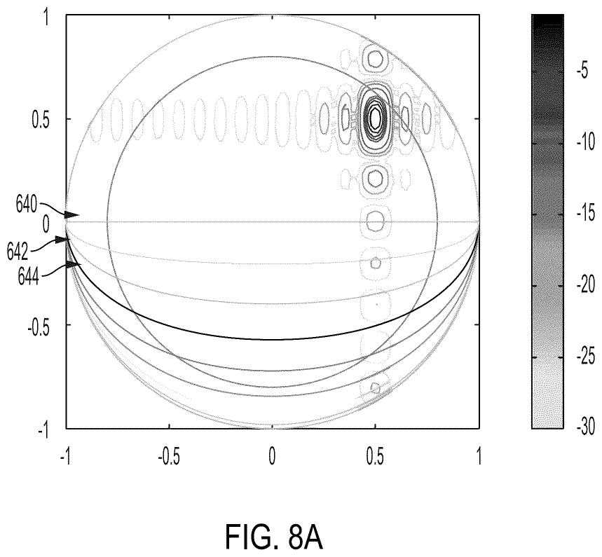

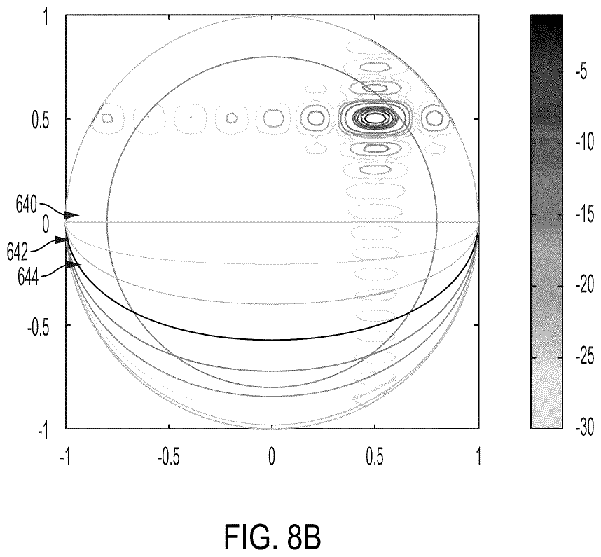

FIGS. 8A-8B illustrate examples of antenna diagrams in a u-v coordinate system.

Various latitudes are shown in each Figure including the GEO arch for a user terminal located at 0° latitude 640, the GEO arch for a user terminal located at 10° N latitude 642, and the GEO arch for a user terminal located at 20° N latitude 644. In these examples, the antenna of the user terminal is rectangular and has an array of 20×10 elements. It is contemplated that the antenna can be pointed toward a low Earth orbit (LEO) satellite and the amount of power radiated toward the GEO arch can be minimized.

FIG. 8A illustrates a first configuration of the antenna electronically divided into two sub-arrays. In this embodiment, the long edge is oriented parallel to the GEO arch.

FIG. 8B illustrates a second configuration of the antenna electronically divided into two sub-arrays. In this embodiment, the long edge is oriented orthogonal to the GEO arch.

For this example, the second configuration shown in FIG. 8B would be more convenient because the antenna pattern intersects the geo arch with the sixth sidelobe (in the case of a user terminal located at 10° N latitude 642), whereas the first configuration intersects the geo arch with the third sidelobe (in the case of a user terminal located at 10° N latitude 642).

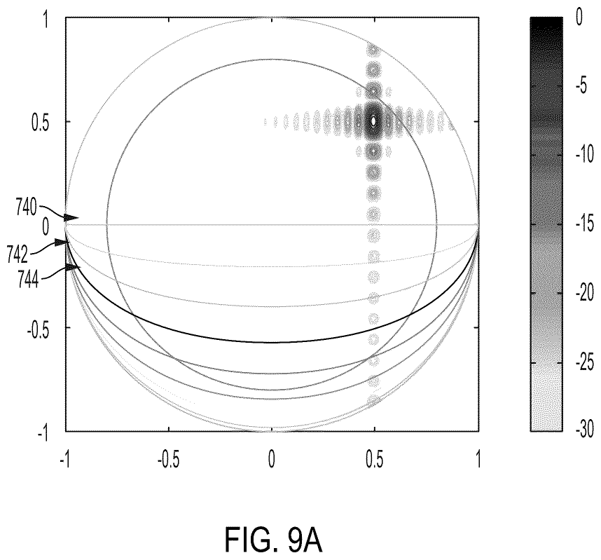

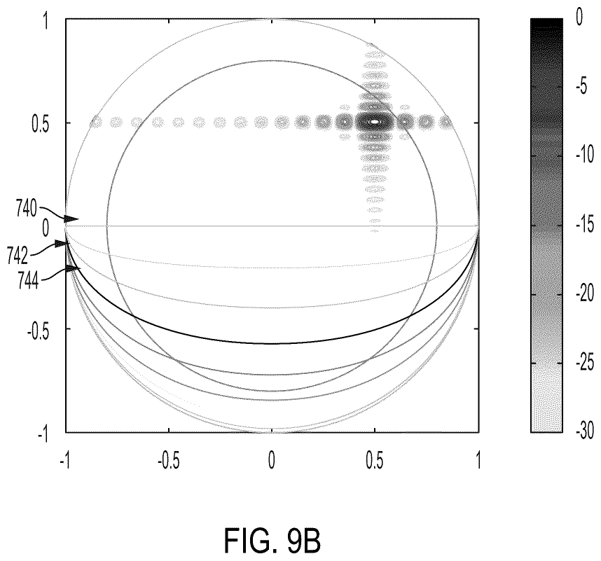

FIGS. 9A-9B illustrate additional examples of antenna diagrams in a u-v coordinate system. Various latitudes are shown in each Figure including the GEO arch for a user terminal located at 0° latitude 740, the GEO arch for a user terminal located at 10° N latitude 742, and the GEO arch for a user terminal located at 20° N latitude 744. In these examples, the antenna of the user terminal is rectangular and has an array of 40×20 elements. It is contemplated that the antenna can be pointed toward a LEO satellite and the amount of power radiated toward the GEO arch can be minimized.

FIG. 9A illustrates a first configuration of the antenna electronically divided into two sub-arrays. In this embodiment, the long edge is oriented parallel to the GEO arch.

FIG. 9B illustrates a second configuration of the antenna electronically divided into two sub-arrays. In this embodiment, the long edge is oriented orthogonal to the GEO arch.

For this example, the second configuration shown in FIG. 9B would be more convenient because interference radiated towards the GEO arch is much lower, when compared with the first configuration shown in FIG. 9B.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A telecommunications antenna for an aircraft, comprising:
a phased array antenna panel comprising a plurality of antenna elements arranged in an array;
electronics configured to electronically divide the plurality of antenna elements into a first set of sub-arrays comprising a first sub-array and a second sub-array, wherein each of the first sub-array and the second sub-array comprises a subset of the plurality of antenna elements, and wherein the first set of sub-arrays collectively comprise the plurality of antenna elements; and
wherein the electronics are further configured to reorient the antenna panel by electronically dividing the plurality of antenna elements into a second set of sub-arrays that is different form the first set of sub-arrays, wherein the second set of sub-arrays comprises a third sub-array and a fourth sub-array, wherein each of the third sub-array and the fourth sub-array comprises a subset of the plurality of antenna elements, and wherein the second set of sub-arrays collectively comprise the plurality of antenna elements.

2. The telecommunications antenna of claim 1, wherein the plurality of antenna elements comprises transmission elements.

3. The telecommunications antenna of claim 1, wherein each of the plurality of antenna elements is fed electronically or with a suited beam forming network.

4. The telecommunications antenna of claim 1, wherein the second sub-array comprises an asymmetric geometry and wherein a beam pattern of the second sub-array is asymmetric.

5. The telecommunications antenna of claim 4, wherein the fourth sub-array comprises an asymmetric geometry and wherein a beam pattern of the fourth sub-array is asymmetric.

6. The telecommunications antenna of claim 5, wherein the beam pattern of the fourth sub-array is rotated 90 degrees with respect to the beam pattern of the second sub-array.

7. The telecommunications antenna of claim 1, wherein the electronics are further configured to reorient the antenna panel by electronically changing a phase shift introduced by the antenna elements of the third sub-array and the fourth sub-array.

8. The telecommunications antenna of claim 1, wherein the first sub-array and the second sub-array comprise separated combination networks in parallel.

9. The telecommunications antenna of claim 1, wherein each of the first sub-array and the second sub-array is configured to point in a different direction.

10. The telecommunications antenna of claim 1, wherein the electronics are configured to reorient the antenna panel dynamically and utilize a total aperture area of the antenna panel.

11. A method for electronically reorienting an analog, phased array antenna having electronics, comprising:
electronically dividing an array of antenna elements of a phased array antenna panel of the antenna into a first sub-array and a second sub-array using a processor of the electronics, wherein each of the first sub-array and the second sub-array comprises a subset of the array of antenna elements, and wherein the first sub-array and the second sub-array collectively form the array of antenna elements;
wherein the processor divides the plurality of antenna elements by electronically changing a phase shift introduced by the antenna elements of the first sub-array and the second sub-array;
electronically reorienting the phased array antenna panel by electronically dividing the array of antenna elements into a third sub-array and a fourth sub-array, wherein the third and fourth sub-arrays each comprises a different subset of the antenna elements than the first and second sub-arrays, and wherein the third and fourth sub-arrays collectively form the array of antenna elements; and
wherein the processor electronically reorients the phased array antenna panel by electronically changing a phase shift introduced by the antenna elements of the third sub-array and the fourth sub-array.

12. The method of claim 11, wherein the plurality of antenna elements comprises transmission elements.

13. The method of claim 11, wherein each of the plurality of antenna elements is fed electronically or with a suited beam forming network.

14. The method of claim 11, wherein the second sub-array comprises an asymmetric geometry and wherein a beam pattern of the second sub-array is asymmetric.

15. The method of claim 14, wherein the fourth sub-array comprises an asymmetric geometry and wherein a beam pattern of the fourth sub-array is asymmetric.

16. The method of claim 15, wherein the beam pattern of the fourth sub-array is rotated 90 degrees with respect to the beam pattern of the second sub-array.

17. The method of claim 11, wherein the antenna comprises a telecommunications antenna disposed on an aircraft.

18. The method of claim 17, wherein electronically reorienting the phased array antenna panel occurs dynamically during flight of the aircraft.

19. The method of claim 11, wherein the first sub-array and the second sub-array comprise separated combination networks in parallel.

20. The method of claim 11, wherein each of the first sub-array and the second sub-array is configured to point in a different direction.
